(19) United States
(12) Patent Application Publication
(10) Pub. No.: US 2009/0188182 A1
(43) Pub. Date: Jul. 30, 2009

(54) PANELS FOR USE IN STAIRCASES, GATES, FENCES AND BALCONIES AND THE METHOD OF MAKING PANELS THEREFORE

(76) Inventor: Antonio Iannotta, Franklin Park, IL (US)

Correspondence Address: Husch Blackwell Sanders Welsh & Katz, 22nd Floor, 120 South Riverside Plaza, Chicago, IL, 60606-3945, US

(21) Appl. No.: 12/363,441

(22) Filed: Jan. 30, 2009

Related U.S. Application Data
(60) Provisional application No. 61/024,816, filed on Jan. 30, 2008.

(51) Int. Cl. E04F 11/02; G05B 19/18; E04B 1/62

(52) U.S. Cl. 52/182; 29/897.3; 700/160; 52/515

(57) ABSTRACT

A method of making a barrier portion of ornamental staircases, balconies and fences is disclosed including the use of a cutting device to create a design panel from a sheet of material. The panels are cut from materials including steel, bronze, aluminum and other metals, alloys, plastics and wood by using cutting devices such as high energy lasers, water jets and routers guided by computer. The panels are cut to emulate wrought iron panels used in prior art staircase and balcony decorative elements without the problems of requiring a skilled installer to forge the elements and weld them together and then install the elements. The panels are pre-finished in factory and are easily assembled; useable in staircases having open and closed stringers such that they can be installed by the homeowner, meet required codes and have long lasting rust free characteristics at a low cost.

### FIELD OF THE INVENTION

The present invention concerns panels used in the assembly of barrier products such as staircase panels, gates, fences and balcony panels for ornamental, safety and security purposes and the method of creating such panels. More particularly the present invention concerns the making of panels that resemble traditional wrought iron, steel or aluminum panels out of singular materials such that problems existing in such prior panels are eliminated with the added benefit of ready to assemble elements that can be installed in all types of staircases, balconies and other barrier products without the need for custom fabrication.

### BACKGROUND OF THE INVENTION

Ornamental staircases, balcony railings, gates and fences are decorative and structural elements that have been part of architecture for centuries. Their stately, elegant looks as well as their sturdy construction and long lasting characteristics have caused these elements to be sought after and prized. However, the costs of such elements and the upkeep needed to keep them looking as new or at least maintained, have added to placing such elements in the desired but not affordable category for all but the very wealthy.

In making traditional ornamental staircases, balcony railings, gates and fences iron rods are cut and curved to desired shapes and welded together with others in a forging process that creates a veritable work of art. The arts or skills associated with panels of the prior art includes metal bending, cutting and shaping and the assembly of the parts in specific patterns by welding and then priming and painting after installation. The panels once created are taken to the installation site where they are assembled together, using welding and other fastening means including attachment to a banister and the closed stringer wall of a staircase or balcony and a top rail or banister. Typically the assembly of the elements by welding of iron parts together at the site of assembly. After welding and installation the elements must be primed and painted for finish. The costs of the materials, the effort to shape them and install them increases the costs of ornamental staircases. Further, architectural wrought iron fences, gates and balconies are prone to rust when exposed to the elements and therefore require considerable upkeep, at great expense, when used in exterior applications. As a result such elements are expensive and therefore rarely applied to exterior architecture and when so applied are either costly to maintain or often found in disrepair.

Prior art ornamental architectural elements have traditionally been created from iron, and lately from aluminum, and require the work of a metal fabricator to prepare the materials for the particular application. A staircase made with ironwork requires design, planning and the ordering of parts. The parts must then be cut to the appropriate sizes, cleaned and welded together. Then an installer must assemble the pieces and prepare the stairway and banister for installation. It will be understood that substantial welding must be done on sight to tie the iron elements together within the staircase to provide the strength and integrity needed to the support heavy iron panels in situ. Iron that must be welded together must be done so in a cleaned and raw state, as such the elements must be made and sent to an installer in a raw state. Materials so sent are vulnerable to surface rust and other damage.

The wrought iron elements, once installed, must be cleaned of any surface rust, debris and sanded to smooth weld points; the elements once cleaned must then be primed and painted at the installation site. It is known by persons having skill in the art that elements so prepared and painted are vulnerable to paint loss upon being struck by common household items (such as a vacuum cleaner or a child's toy).

Further, it is well known to persons having skill in the art that such pieces can only be installed in closed stringer staircases, as the iron ends must be anchored within the stringer of a stairway. The closed stringer providing a place to anchor the pieces and provides a straight line element such that an uneven opening, between the pieces and the stair tread, in violation of safety codes (typically wherein an opening having a diameter smaller than 4 inches is required to protect small children from harm) will not be created. As such, these prior art pieces can only be installed in closed stringer staircases. In most cases panels of the prior art placed on open stringer staircases will not pass state and national safety standards requiring that no object larger than 4 inches (and in some standards 6 inches) be able to pass through the elements of the panel. As such only closed stringer stairways can include prior art wrought iron stairway elements. This limitation forecloses the use of such ornamental stairways from those who do not desire the closed stringer stairway.

One more modem approach in the making of staircases and balconies is found in U.S. Pat. Nos. 5,820,111 and 6,059,269, issued to Nancy A. Ross. The Ross patents disclose the use of iron panels that are made in advance but have elements that must be welded together in situ to create a staircase. These panels, while providing a degree of modernization over the prior art methods and panels, still require the work of skilled artisans to weld and otherwise fasten the panels together to create a staircase. Further, the patents note the limitations that the staircases are limited to inclinations of between 25 and 50 degrees and limited to their use on closed stringer staircases, or specialized base support members, so that the panels will be in compliance with state and national building codes. While a further step in the art, these patents describe a process wherein the panels must be installed by skilled artisans in a more or less custom installation; there are limitations as to the inclination of the staircase; and finishing must be done at the site of the installation (due to necessary welding and forming on site). Further, persons wishing to use staircases made in accordance with the '111 and '269 patents would have to modify the pieces by bending and/or adding bars, welding and/or fastening parts together, all requiring a skilled installer at considerable cost, in order to not provide an opening, between the panels and the tread, of greater than a 4 inch diameter, as prohibited by building codes. Embodiments of the present invention overcome all of these limitations.

### SUMMARY OF THE INVENTION

In accordance with the present invention, a method of making an ornamental staircase, balcony, gate, fence or the like from a series of easily installable panels is disclosed. The method includes the creation of a number of singular panel elements, each being created from a single sheet of material by cutting away elements of the sheet, including cutting the sheet so as to include attachment elements. It will be understood that the sheet of material can be of any structurally sound product, such as steel, aluminum, bronze, stainless steel, graphite, alloys, plastics, wood or other material that can be made into appropriate size and thickness sheets and which can be cut.

The panel created from the sheet is surface treated at the time of manufacturing so as to provide a permanent protective coating for the panel; the surface coating including powder coatings, primers and paints, emulsions, plastic, rubber and other protective coating materials. The coatings can include color coats to provide protection and decoration. The coating provides permanent protection to the panel as assembly of panels into decorative barrier products, requires no further cutting or welding that would damage the coating. Assembly of the barrier products is created by juxtaposing one or more panels along side each other so as to make a desired design and then fixing them in the order desired by installing them.

Installation can be effected by making openings in a top rail (such as a banister) and a floor or tread of a step and installing the panels individually by inserting the attachment elements within openings made cooperatively in a top and a bottom rail of the staircase, balcony or fence. Epoxy or other glues, mastics or affixing means can be added within the openings so as to affix the panel. Holders can also be used to hold panels in place while not causing damage to support surfaces, as will be explained below.

The panels created for use in the above method can be sold as a series of panels at a retail outlet such that the panels can be purchased and installed by an individual. The panels, used as design elements of a stairway, balcony, gate or fence barriers can comprise one or more panels, each being cut from a single sheet of material. Each panel so created has a top and bottom, a front and back and a left side and a right side. In one embodiment, some panels can be cut with attachment means, such as one or more rods extending from the panel top and bottom. Each panel can comprise an individual design such that they can be mixed and matched, rotated 180 degrees to create different looks when assembled adjacent a similar panel not rotated, and assembled together to make a plethora of designs when joined together. In the preferred embodiment, each panel is coated to a finished appearance upon manufacture. The barrier element is created by the assembly of the one or more panels adjacent one another by attaching each, at its top and bottom, to the structural elements of the stairway, balcony or fence.

In a preferred embodiment, panels are created by cutting the sheet of material with a high-energy cutting device, such as for example a CNC plasma cutter table. In one embodiment the panels are made of steel, in another embodiment of aluminum and in a third embodiment of a PVC grade plastic. In another embodiment, the panels are made of wood and are cut by a computer guided router. The assembly of the panels to the structure of the fence, gate, staircase or balcony is made without welding and is instead done by mechanical means including fastening each panel to a top and bottom rail and therefore can be done by the home owner or any craftsman with minimal skills and no welding skills or machinery. It will be understood that where panels are made without attachment means, rods or other means of attachment can be welded or otherwise fastened to the panel prior to the final finishing; the rods can then be cut to fit for certain applications including cut to fit at the site of assembly.

A more detailed explanation of the invention is provided in the following description and claims and is illustrated in the accompanying drawings.

### BRIEF DESCRIPTION OF THE DRAWINGS

FIG. 1 is a perspective view of a staircase, with balcony, made in accordance with the teachings of the present invention.

FIG. 2 is an elevational view of a staircase with panels of the present invention in place.

FIG. 3 is an elevational view of another staircase with panels of the present invention in place.

FIG. 4 is a perspective view of an exterior balcony made in accordance with the teachings of the present invention.

FIG. 5 is a perspective view of an interior balcony and staircase made in accordance with the teachings of the present invention.

FIG. 6 is an elevational view of a staircase panel made in accordance with the present invention.

FIG. 7a is an elevational view of a balcony or gate double panel made in accordance with the present invention.

FIG. 7B is an elevational view of a balcony or gate single panel made in accordance with the present invention.

FIG. 8 is a schematic representation of a staircase.

FIG. 9 is an elevation view of a staircase.

FIG. 9a is an elevational view of a panel exploded from a staircase.

FIG. 9b is a perspective view of a holder for use in installing panels of the present invention.

FIG. 10 is a flow chart of steps used to create a panel and staircase.

FIG. 11 is a perspective view of a computer directed cutting machine used in the method of the present invention.

FIG. 12 is a perspective view of panels being cut on a cutting machine

FIG. 13 is a perspective view of cut panels on a cutting machine.

FIG. 14 is an elevation view showing a panel cut from a sheet of material.

FIG. 15 is a chart of material sizes for use in the method of the present application.

### DETAILED DESCRIPTION OF THE ILLUSTRATIVE EMBODIMENT

While the present invention is susceptible of embodiment in various forms, there are shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

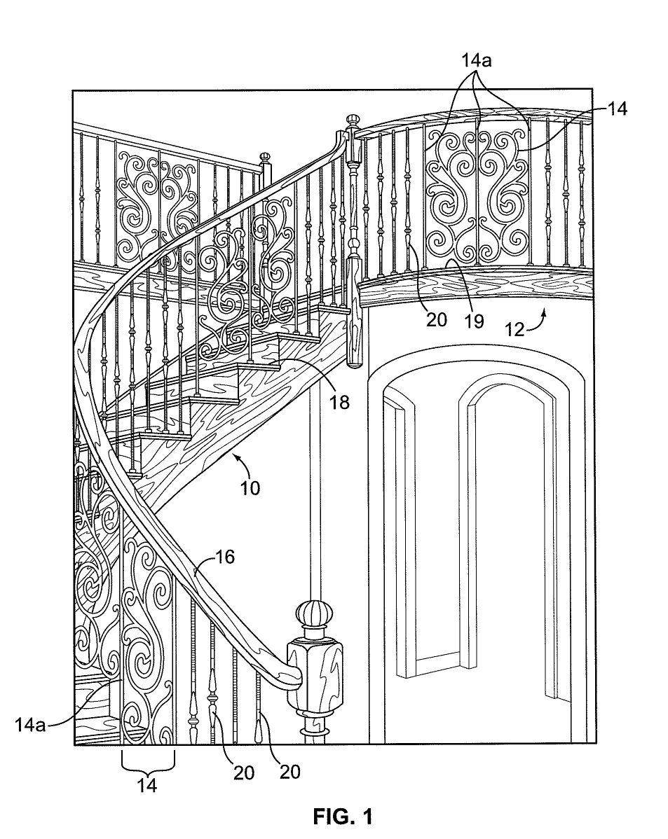

Referring to the drawings, FIG. 1 represents a staircase 10 having a balcony portion 12 all made in accordance with the teachings of the present invention. The staircase and balcony portions are made from panels 14 cut from a unitary sheet of material (as explained in greater detail below) and simply inserted and cemented to the banister 16 and tread 18 of a staircase 10 or balcony portion 12. Upon viewing the staircase 10, it would be unclear to the ordinary observer as to whether the staircase was produced using the time honored teachings of the prior art, which include forming individual elements 14a of each panel 14 and welding those elements together to produce the panels, welding panels together in situ to form the barrier/decorative portion of the stairway while simultaneously attaching the iron to a closed stringer element (see FIG. 3) and then finishing the iron portion of the stairway with various primers and paints. A person having skill in the art, on the other hand, would notice that the staircase and balcony portions shown in FIG. 1 could not be made in accordance with the teachings of the prior art as the staircase is an open stringer type staircase (as explained below) on which wrought iron-type decorative panels cannot be used. Because the prior art has this limitation, open stringer staircase, which provide a view of the steps, or treads, as viewed from the outside of the staircase and are considered more airy and light, could never before used.

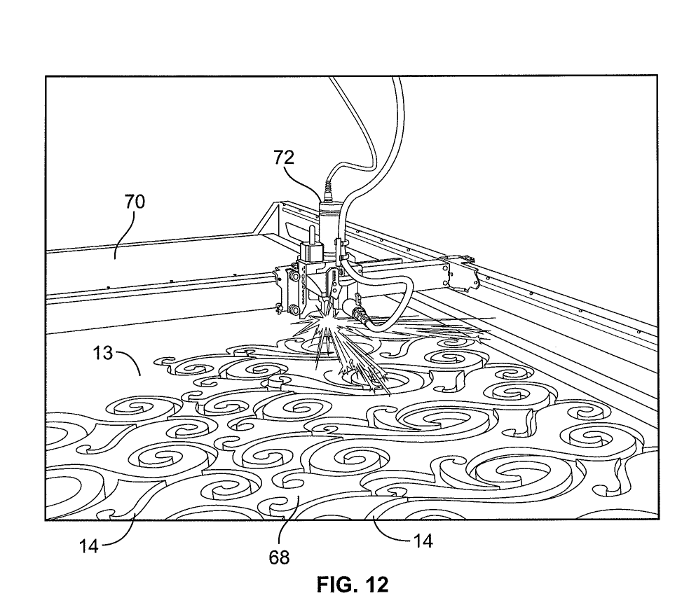

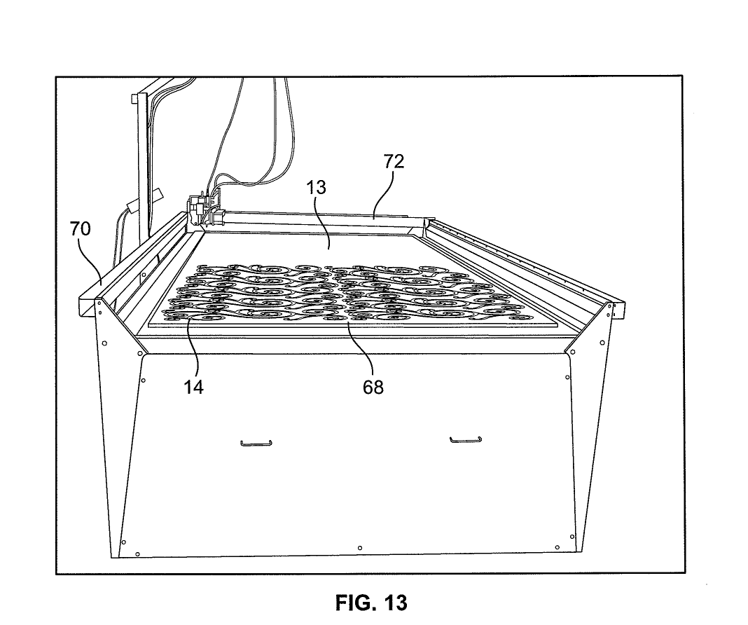

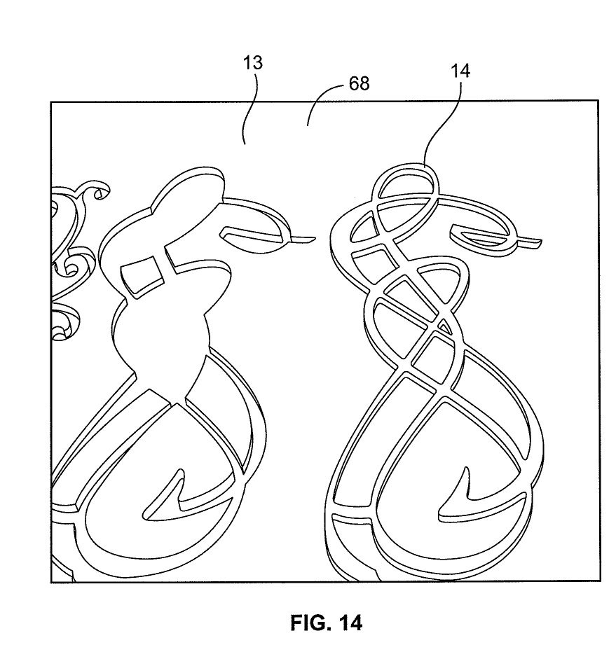

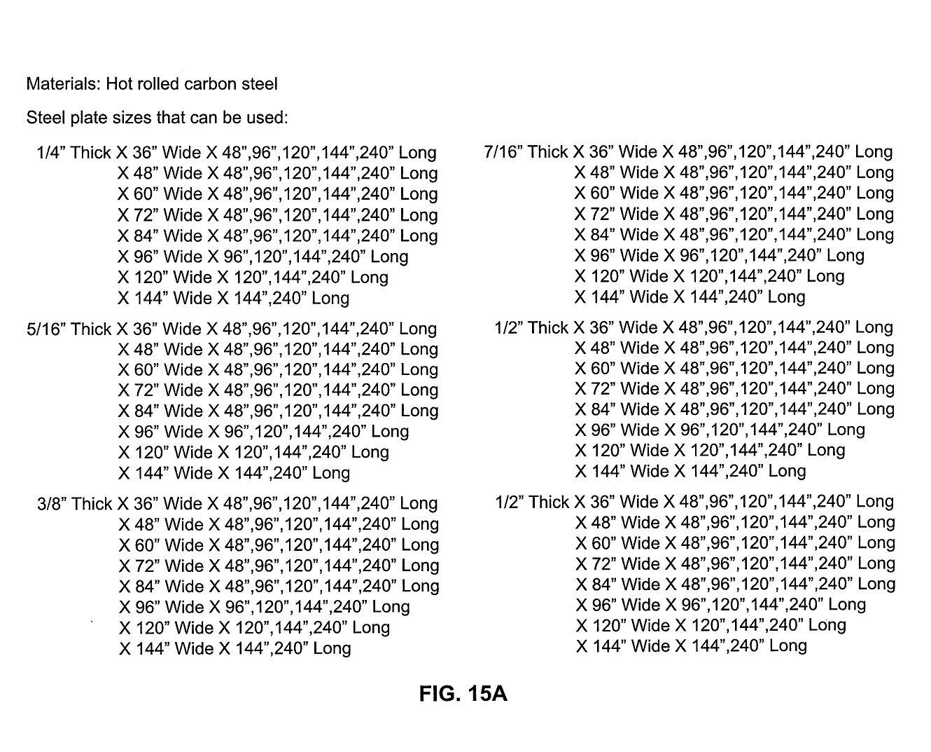

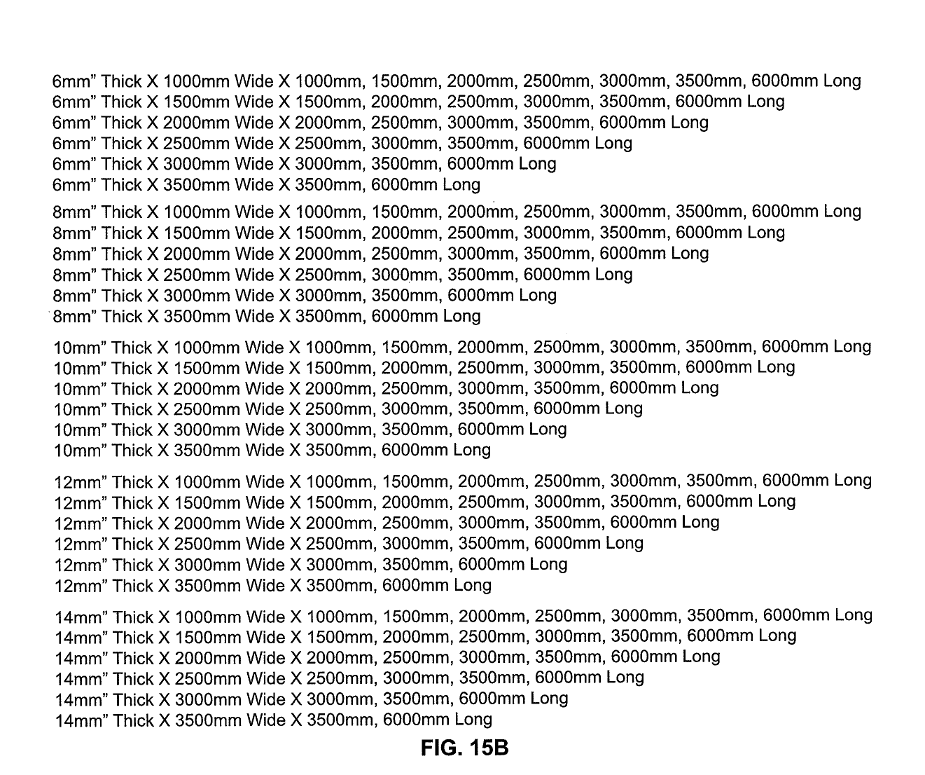

As seen in FIG. 1, the panels 14, as well as balustrades 20, of the decorative elements are attached to the banister above and then directly into the stair tread 18 (or floor 19, in the case of balcony portions 12). Panels 14, rather than being individual rods welded together as in the prior art, are each a single unitary panel made by cutting a sheet of material (and bending if and as desired and coating as described below), such as steel or aluminum, copper, bronze, stainless steel, carbon fiber products, graphite and other metals and composites having structural properties sufficient for these purposes. The sheets of material 13, as shown in FIGS. 12, 13 and 14 are of various sizes and thickness as deemed necessary. The sheets are cut to create panels 14 (FIG. 14) and the barrier product is created by attaching the panels 14 to the banister and tread, or in some embodiments, to a decorative rail running parallel to the general plane of the floor or stairs.

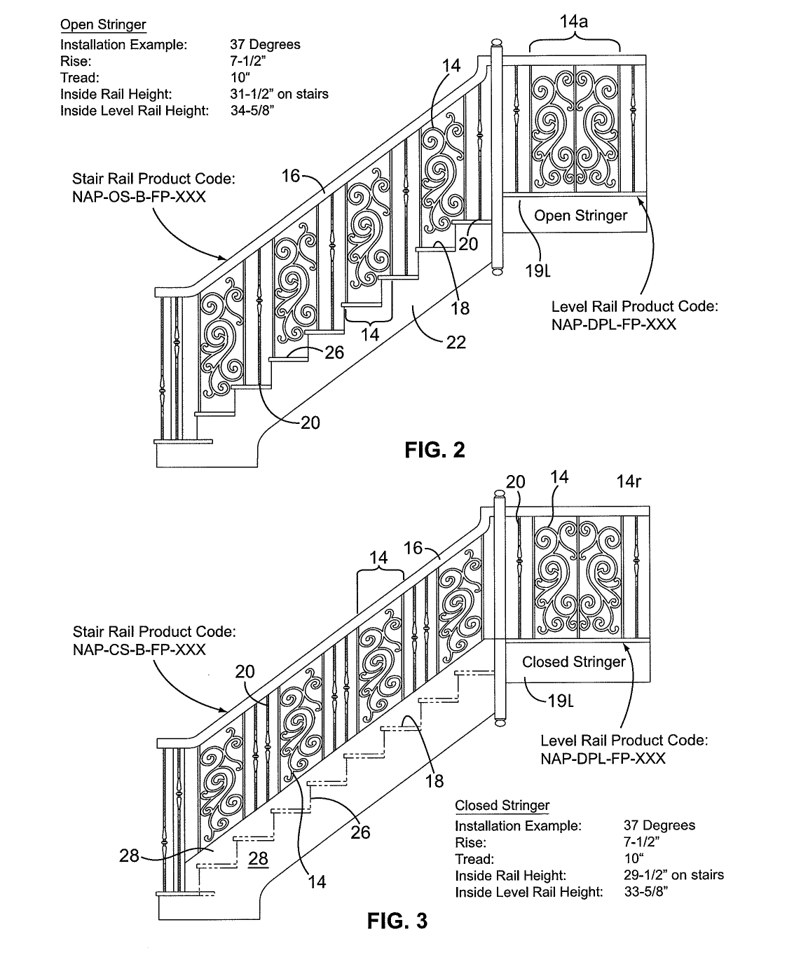

Referring now to FIGS. 2 and 3, elevational views, respectively, of an open 22 and closed stringer 24 staircase are shown. It will be understood that a closed stringer is defined as a staircase in which the tread portions 26 of the staircase are closed in by a solid panel 28 running along side of the staircase for the purpose of producing a more finished staircase look. In FIG. 3, the treads 26 are shown in phantom to show their positioning in the staircase 24 with respect to the position to solid panel 28. As can be seen in FIGS. 2 and 3, the staircase panels 14 of the present invention can be installed in both closed and open stringer staircases. It will also be seen that level panels 14a, for use in gates, fences and balconies that require no rise (as seen in a stairway) are also applicable to both types of stringers. As noted in the legends associated with FIGS. 2 and 3, the main difference in the panels 14, used with open and closed stringers, is the lengths of the design of the panels.

In FIGS. 2 and 3 rod portions 14r are shown as the elements used to connect panels to staircases. It will be understood by persons having ordinary skill in the art that rod portions 14r can be created in the same cutting process used to create the entirety of panels 14, or can be made by attaching rods of material to the previously created panels prior to final cleaning and finishing of the panels, as will be described in greater detail below. It will be understood that rod portions 14r, whether created with the panel or attached afterwards, can be cut to accommodate variations in height, such that if a number of open stringer panels are purchased for a closed stringer staircase, rod portions 14r can be cut to accommodate the shorter span therein.

FIGS. 2 and 3 show the remaining staircase parts, a banister 16, tread surfaces 18 and balustrades 20. It can also be seen that level panels 14a are used on the landing portions 191 of staircases. In FIGS. 2 and 3, landing portion panel 14a are shown as double panels, it will be understood that double panels are made in the manner that single panels are made and typically constitute the use of a pattern that appears as two single panel units or can include the rotation of one panel, relative to the other to produce a pleasing effect. It will also be understood that a similar effect can be made using two single panel assembled together with one panel rotated 180 degrees, the difference being that the two panel system will include a double rod portion 14a in the center of the design element (not shown). Such doubled panels can also be separated to produce a similar, but slightly different look. It will be understood that the rotation of panels by 180 degrees along the incline of a staircase can also be made, making an additional decorative effect along a staircase panel.

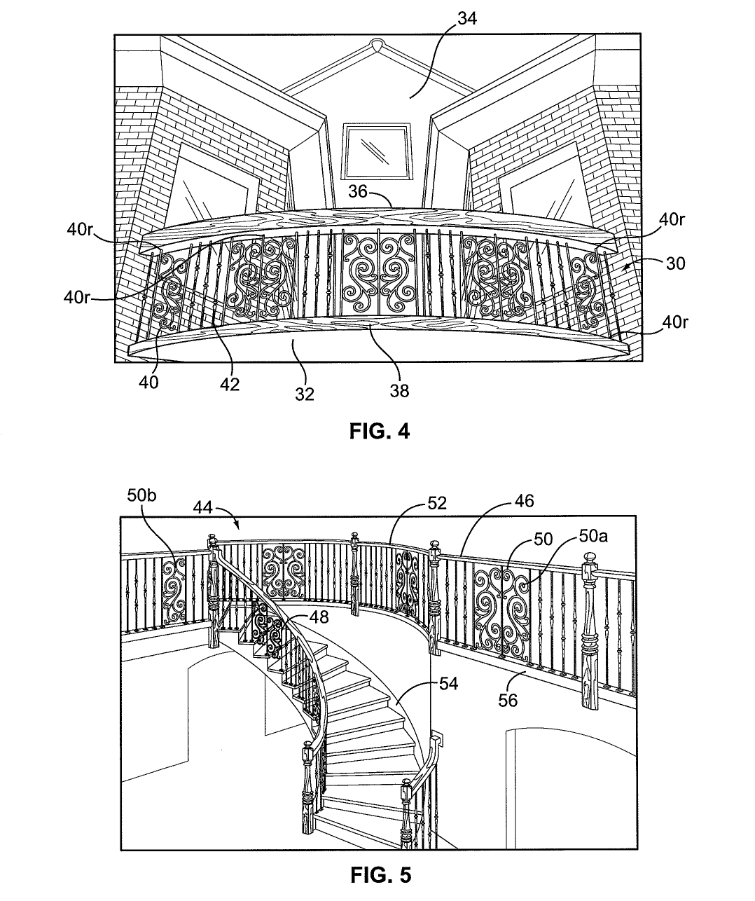

In FIG. 4 an exterior balcony railing 30 is shown in position on a balcony 32 of a house 34. The balcony railing is a wood banister 36 above as well as a wood rail 38 below, such as pressure treated wood. It will be understood that similar elements can be used to create barriers for wood deck, as are commonly found in back yards. It will be seen that panels 40 and balustrades 42 are attached between the banister 36 and rail 38 in a manner similar to that shown in the staircases of FIGS. 1 through 3, with the exception that all of the attachment rods 40r used in constructing the balcony would be of the same length (as shown in FIGS. 7a and 7b). constructed using an upper railing 36 and lower railing 38 to which level panels 40 and balustrades 42 are attached.

In prior art balconies, of this type, assembly was made by welding of elements; each part of a panel of the prior art must be formed and welded together. A clean bare metal surface must be available to join elements together by welding; welding, therefore requires that metals be unfinished during assembly (as welding cannot be made on finished surfaces) and then finished with paint or other coatings afterwards. The creation of a panel by these methods includes the creation of dozens of weld spots each susceptible to elemental deterioration. As the metal is unfinished during this process and is exposed to the elements the elements that cause rust are present on the metal. Imperfections in paint and the weakness of such coatings cause the breakdown of such coatings with time, allowing rust to form. In sharp contrast, the method of the present invention, which calls for the creation of entire panels from one piece of material and the finishing of the material in factory, does not allow exposure to deleterious elements.

While welding of rods to panels in the present invention is under certain conditions an acceptable manner of joining elements, it will be understood that welding of a panel to a rod in the present invention welding is done in a factory or assembly point situation, where powder coating or other superior methods of finishing are available to finish the products properly and not at the site of assembly as has been done using the teachings of the prior art.

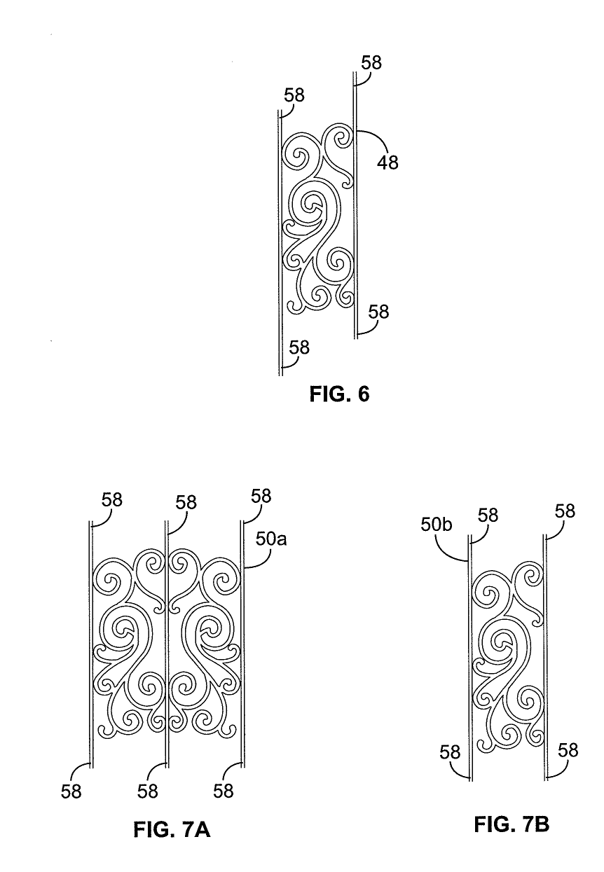

Referring to FIG. 5, an interior staircase 44, with balcony portions 46, is shown. The staircase 44 includes incline panels 48 while the balcony portions 46 include level panels 50 (see FIGS. 6, 7a and 7b). As shown in FIG. 5, level panels 50 are shown in double panel units 50a and single panel units 50b. The staircase 44 shown is an open stringer staircase, which as is known in the art is prohibitively expensive to create using panels of the prior art. The panels 48, 50 are attached to the banister 52, treads 54 and floor 56, by means of corresponding holes made in those surfaces of a size configured for panel rods 58 (shown in FIGS. 6 and 7a and 7b and 9).

In the creation of a staircase, wherein there is an inclination, the panels will of course anchored at different elevations along the length of the staircase. As shown in several of the figures, but most particularly in FIG. 6, such panels are made to accommodate the inclination of the staircase. One aspect of such inclination is that the design is not inclined as a result but instead progresses up the inclination level. Table I is used to determine the type of panel, design of the panel and the inclination and finish of the panel to a person ordering a staircase made in accordance with the teachings of the present invention. The table also includes entries for staircases that are straight and those that include an elegant curve (such as that shown in FIG. 1 and FIG. 5). It will be understood, and it is shown in Table I, that staircases of the present invention can include those having an inclination as shallow as 20 degrees and those having an inclination as great as 52 degrees in a ready to install situation. Persons having ordinary skill in the art will understand that staircase of lesser and greater inclination can be constructed using the method and devices of the present invention but that staircases having lesser and greater inclinations than those illustrated are rarely desired and made. All of these angles are provided in any of the combinations and permutations shown in Table I; however, it will be understood by persons having skill in the art that Tables I and II are illustrative and not meant to be all inclusive; variations on what is noted are within the novel scope of the present invention.

TABLE I
Stair Part Numbers
11 digit code xxx-xx-x-xx#-xxx

| | 2. Staircase | 3. Staircase | 4. Flat or | |
|---|---|---|---|---|
| 1. Design | Type | Angle | Curved | 5. Finish |
| NAP = | OS = Open | A = 20 to 30 | FP = Flat | XXX = |
| Napoli | | degree angles | Panel | Standard |
| MOD = | CS = Closed | B = 30 to 45 | CL = Curved | XXX = |
| Moderno | | degree angles | Left | Specialty |
| CLR = | | C = 45 to 52 | CR = Curved | NF1 = Non- |
| Classico | | degree angles | Right | Finished |
| Rotondo | | | | |
| CAP = | | | Specify | |
| Capri | | | Radius | |
| ROM = | | | | |
| Romana | | | | |

STAIR PART NUMBER: CLR-OS-B-CR8-SB1

For level rails, gates, balconies and fences, where the ornamental portion of the barrier remains generally level, Table II provides a means for presenting all of the present variations of these panels, including the radius of curvature of curved panels (and generally the barrier to be constructed). It will be seen that the design and finish as well as whether a single or double design pane and whether flat or curved is desired are selectable. Examples of the panels selectable are shown in the figures, but most specifically in FIGS. 7a and 7b; barriers made with these panels are shown in FIGS. 1 (balcony portion 12) and 3.

TABLE II
Level Rail Numbers
11 digit code xxx-xxx-xx#-xxx

| | | 3. Flat or | |
|---|---|---|---|
| 1. Design | 2. Panel Type | Curved | 4. Finish |
| NAP = | SPL = Single | FP = Flat | XXX = |
| Napoli | Panel Level | Panel | Standard |
| MOD = | DPL = Double | CL = Curved | XXX = |
| Moderno | Panel Level | Left | Specialty |
| CLR = | | CR = Curved | NF1 = Non- |
| Classico | | Right | Finished |
| Rotondo | | | |
| CAP = | | CP = Curved | |
| Capri | | Panel | |
| | | Specify | |
| | | Radius | |
| ROM = | | | |
| Romana | | | |

LEVEL PART NUMBER: CLR-DPL-CP8-SB1

TABLE III
Finishes

| | | | | III. Non- | |
|---|---|---|---|---|---|
| I. Standard | Codes | II. Specialty | Codes | Finished | Codes |
| Satin Black | SB1 | Oil Rubbed | ORB | Non- | NF1 |
| | | Bronze | | Finished | |
| Copper Vein | CV1 | Oil Rubbed | ORC | | |
| | | Copper | | | |
| Silver Vein | SC1 | Antique | AN1 | | |
| | | Nickel | | | |

As shown in the tables, the curvature of the barrier product is an additional item to be specified when classifying and then ordering parts in accordance with the teachings of the present invention. As shown in the tables, the example ordered in Table I (CLR-OS-B-CR8-SB1) is a staircase having the Classico Rotondo design (this is one example of the decorative panel design) for use on an open stringer staircase having an inclination of between 30 and 45 degrees, curved right with a radius of 8 in Satin Black finish. In Table II (CLR-DPL-CP8-SB1) the corresponding balcony panels are being specified as Classico Rotondo, Double Panel level having a curved panel with a radius of 8 and a Satin Black finish. It will be understood that the choice of one design is for illustrative purposes and that no limitation is meant thereby.

It will be understood that Tables I, II and III are presented as illustrative of a method of selecting and numbering various panels made in accordance with the teaching of the present invention. The tables are not meant to limit the numbers and types of panels that can be produced by the method or device of the present invention and are merely meant to be illustrative.

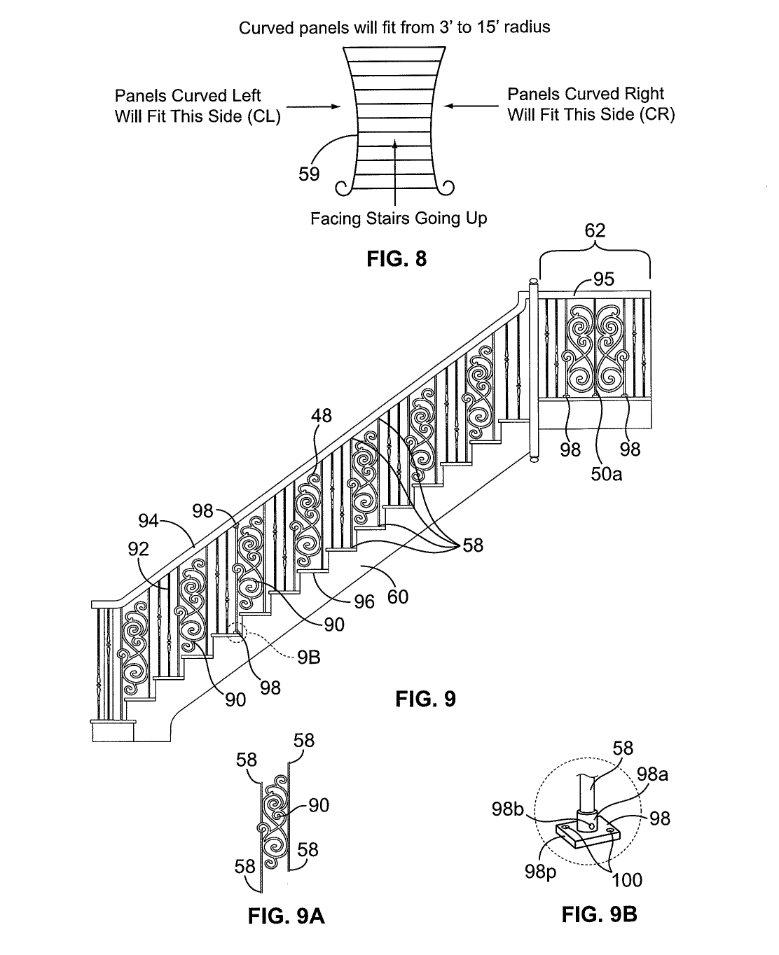

FIG. 8 is a representation of a staircase 59 having curved sections. It will be understood by persons having ordinary skill in the art that staircases will have straight and curved sections and that panel elements can be made, in accordance with the teachings of the present invention (and as is shown in tables I and II) with curves created to fit the curvature of a staircase. A curved staircase is also shown in FIGS. 1 and 5, and a curved balcony is shown in FIG. 4. In each of these examples curved panels are provided. In a preferred embodiment of the present invention such panels, flat, curved, inclined, level, with various finishes will be available for immediate purchase and installation (without the need for welding). A kit of parts can be created so as to facilitate the creation of particular staircases (or balconies, etc.) or individual parts can be sold to allow for a more unique and one-off staircase design. In a preferred embodiment the parts are ordered and created, in the manner described below, quickly and ready for installation.

By review of tables I and II it can be seen that panel sizes, shapes, designs, finishes and other elements can be called for by using simple codes (as explained in tables I and II) clearly describing all of the available elements of the panel desired and thereby facilitating the ordering of the barrier parts. FIG. 8 is a representation of a staircase, a representation of the type needed to schematically define the staircase and order the appropriate parts.

As shown in FIG. 9 a staircase 60, made with the elements shown in FIG. 1, single panels 48, having means for installation along the inclination of the staircase and panel 50a, a double panel, is installed on the level portion of the staircase/balcony portion 62.

Persons having ordinary skill in the art will understand that prior art fences, gates, balconies and staircases of the type described herein, are available through various manufacturing means most of which are based on bending and welding of individual iron bars together to make panels in a manner that has been used for centuries. The present invention is an updated approach to the manufacture of parts and elements of staircases, balconies, gates and fences that allows for the stocking of many sizes and shapes of panels for various uses, installation by any person including those not having skill in welding, and without the need for custom manufacturing of panels. Further, the process disclosed produces panels that are better suited for outdoor use as there are fewer connections or joints needed to create these panels, thereby allowing for longer lasting durability such as through improved protection from rust and other elemental processes.

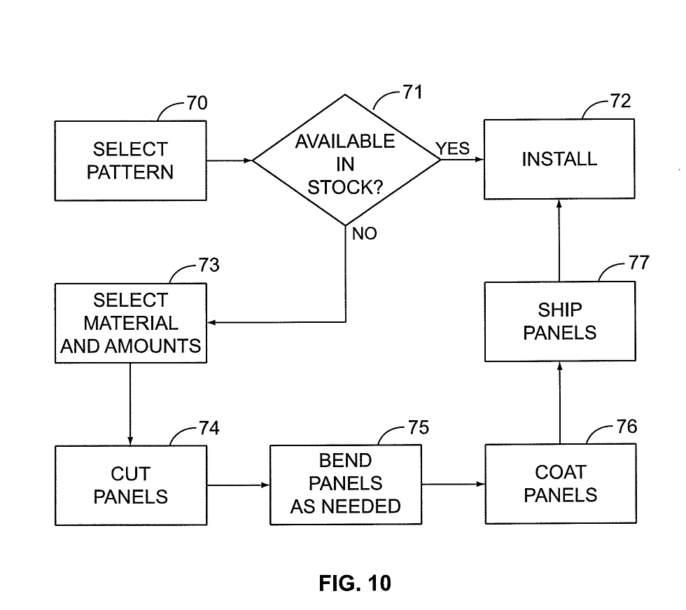

In the process of creation of a barrier product, as shown in FIG. 10, such as a staircase, balcony, gate, fence or other, the panel, a pattern is selected 70, from the various designs (classical, modem and others) available or a new design is programmed into the computer adapted to control the cutting machine (as described below) and stock of the panels is checked 71. If the pane is available in stock it is prepared for installation 72. If it is not available, the material desired is selected 73 and the desired panels are cut 74 from sheets of the material selected. If the barrier product is designed with a curve, the panels are bent as necessary 75 to create the curve. Whether curved or not, the panels then proceed to the coating process 76 (as described below) and as necessary the panels are shipped 77 to the purchase site or directly to the site of installation and the panels are then installed 72.

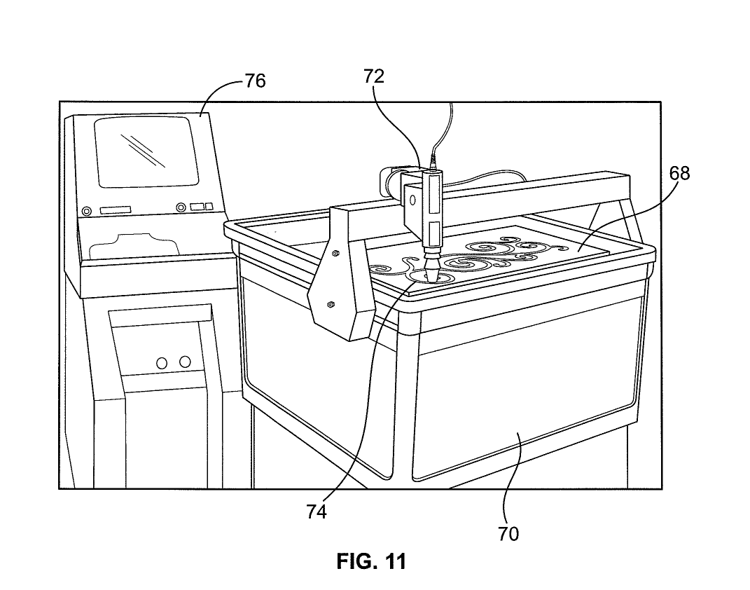

The manufacturing process for the panels of the present invention includes a process that makes panel designs in one continuous piece. A steel plate 68, or other structural material plate, ranging from various sizes and thickness (including those shown in FIG. 12) can be placed on a cutting machine, including in a preferred embodiment a CNC plasma cutter 80 table shown in FIG. 11 for forming. Persons having skill in the art will recognize the benefits of employing a CNC plasma cutter table, however, it will be understood that any device capable of cutting materials of this type can be used in the process of the present invention without departing from the novel scope of the invention. As a substitute for a CNC Laser Cutter a Water Jet Cutter, a router (for use on woods and plastics) or any other device that can cut a pattern of choice into the selected materials and provide desired results can be used without departing from the novel scope of the present invention. It will also be understood by persons having ordinary skill in the art that other materials can be used to substitute for steel plates without departing from the novel scope of the present invention. It will also be understood that the listing of plates, as shown in FIG. 12, is for illustrative purposes only and no limitation on sizes is implied by the listing, other plates of various sizes, including those not listed in table 1 can be used in the method of the present invention.

In one preferred embodiment of the present invention a plasma cutter machine 80, consisting of a cutter 82, table 84, and a computer 86 is programmed with a design pattern of a desired panel. The pattern is fed into the computer 86, and used to cut the sheet of material 68 in order for the material, such as sheet metal, to be cut, into predetermined specifications established, into multiple iron-look panels (as shown in various figures). Designs include traditional panel designs as well as modem and diverse designs ranging from simple patterns to almost any pattern that a purchaser may desire.

Each pattern type created, in the practice of the present invention, is designed using Computer Aided Design programs such as CAD. It will be understood that any pattern design process, including free hand drawing of designs can be utilized without departing from the novel scope of the present invention. Each pattern created can be used as fit for a variety of applications, including staircases, balconies, gates, fences and others, to include use for various rail heights, various angles, close and open stringer staircases, straight and curved staircases, and for interior and exterior use. As noted, the panels are used for, but not limited to, stairway railings, balconies, gates, and fences and can also be used a decorative panels for other uses such as simply decorations, furniture support, gate and fence designs and others, without departing from the novel scope of the present invention.

It will be understood by persons having skill in the art that the panels made using the process of the present invention include the following characteristics:
1) The ability to apply these patterns/panels in open and closed stringer staircase uses is based on the development of these designs and the ability to resize the design, as needed using CAD. It will be understood that the creation of a design that is applicable to both open and closed stringer staircases and is available as a stock item (rather than custom made) is possible as a result of the specific designs created and the creation of the panels using the present process. The prior art does not allow for both open and closed stringers with a single panel design.
2) The ability to apply these patterns/panels for all rail heights is based on a market investigation and analysis to identify appropriate ranges to meet all stairway height requirements. This research has been incorporated in the process of the present invention. There is no set height established in the industry. Therefore every stairway manufacturer, builder, finished carpenter, homeowner, or anyone putting together a staircase can set rail heights at different levels. The prior art presently permits panel creation to only one height.
3) Acceptability of the barrier products under national and state codes requiring safety for children and specify the size of an object that cannot penetrate the barrier.

Once the material of the panel, in one embodiment, iron, has been cut into a pattern, the piece(s) are cleaned for a paint-ready finished product. This process is/can be conducted in one of three ways. First, and preferably, the panels are put into a “shot blast machine” which uses metal shot to remove all mill scale and any other debris from the cutting process. This process produces a smooth surface ready for finishing to be conducted. In other embodiments, the panels can be smoothed by sandblasting, or by manually sanding the patterns/panels that are ready-to-paint.

Once the pattern/panel is in a ready-to-paint phase, two things can occur: First, a bar or stanchion can be added on either end of a single or double pattern/panel by welding it manually or by using a welding robot or multiple panels can be welded together manually or using a welding robot to form a longer area and then a bar or stanchion is added on both sides of the pattern/panel. It will be understood by persons having ordinary skill in the art that any manner of connecting the panel to the bar can be utilized without departing from the novel scope of the present invention. It will also be understood that the bar or stanchion of the present invention can be created by cutting it as part of the panel design and cut introduced above, such a panel that includes bar or stanchions could be created by using material having appropriate structural capabilities and would provide the ideal one-piece panel. The product is then sanded where bars have been added for a smooth surface and ready for finishing. The installer needs only to cut the length of the side-straight bars to desired length to center panel and drill holes on top and bottom of stair thread or stringer, and on top of handrail; or, the pattern/panel is left as is without any bars on a single or double pattern/panel and is sold to a fabricator or individual to use as necessary.

The pattern/panel can be finished at the site of manufacture or can be sent off-site, to a special finishing location, for finishing to be conducted. This includes painting and/or powder coating of the pattern/panel. The end-user receives a product that is ready for installation on-site.

Installation of panels made in accordance with the present invention is done simply by drilling or otherwise opening appropriate holes in upper and lower support members. The support members can include the tread of a staircase, the closed stringer framing, a specific longitudinal railing (attached to walls or balustrades) above and/or below the panel as well as a banister or top rail. Each panel, as disclosed above, and as specifically shown in FIGS. 9 and 9a, include rods 58 that are specifically for insertion or attachment of the panel 90 into a barrier product (staircase, fence, gate, balcony, etc.). In a normal installation panels 90 are brought together and typically laid out in order of installation. Holes are bored or drilled into the tread or floor 96 of a staircase 60 or balcony portion 62 and in a banister 94. It will be understood by persons having skill in the art that a template showing the appropriate location of holes can be provided to the installer to facilitate installation. The holes are filled with an epoxy, or other mastic (particularly one that will allow for flexibility due to the combination of differing materials, such as steel and wood, such that varying rates of expansion and contraction of materials can be accommodated), and rods 58 are attached thereby. Once the panels are in place, as well as any balustrades 92 desired, the banister 94 and/or top rail 95 can be installed in a similar manner as noted above; that is the creation of holes in the lower surface, the application of epoxy or mastic and the attachment of the banister/rail onto the rods 58. Therefore, in the use of a single panel such as panel 48 in FIG. 6, four holes are needed to attach the panel above and below; in the use of a double panel such as double panel 50a in FIG. 7b, six holes must be made.

It will be understood by persons having ordinary skill in the art that rods 58 are typically of one size and that the panel portions are made to varying lengths to accommodate either open or closed stringer staircases or balconies. However, in one embodiment, rods 58 can be made to any appropriate length as desired by a person ordering custom panels; allowing for the use of the panels in any situation including open and closed stringer staircases and other situations. Panels made for distribution as ready made can include sets designed for closed stringer staircases, thereby having smaller length panels or for open stringer staircases, thereby having longer length panels.

In another embodiment of the present invention, in situations where the cutting of holes into a floor or banister is not desired or desirable or a temporary barrier product is desired, a holder 98 of the type shown in FIG. 9b can be used. Holder 98 includes a receptor 98a into which rods 58 can be inserted and a plate 98p, having attachment means 100 (such as screws or other fasteners and the openings necessary thereto) for attachment to a floor or other surface. It will be understood that the lower surface of some holders 98 can include a friction plate such that the holder can be held in place by friction alone, as may be desired for use with temporary barriers or barriers for which are alternatively moved and then affixed. In one preferred embodiment holder 98 will include a set screw 98b in receptor 98a to assist in holding rod 58 (and thereby panel 90) in place. It will be understood by persons having ordinary skill in the art that one type of holder has been illustrated but that other types of holding means can be substituted therefore without departing from the novel scope of the present invention. Further, persons having skill in the art will understand that a combination of holding means can be used such that holders 98 can be used for attachment to a floor while holes and epoxy can be used to attach a rail or banister to a barrier product, without departing from the novel scope of the present invention.

It will be understood that while certain machines and materials have been shown and described, other materials and machines can be used by persons having ordinary skill in the art without departing from the novel scope of the present invention. Although an illustrative embodiment of the invention has been shown and described, it is to be understood that various modifications and substitutions may be made by those skilled in the art without departing from the novel spirit and scope of the invention.

What is claimed is:

1. A method of making the ornamental portion of a staircase, balcony or fence from a series of easily installable panels comprising the steps of:
creating a panel element from a sheet of material by cutting away elements of the sheet to make a desired design;
surface treating the singular panel at the time of manufacturing so as to provide a protective coating;
juxtaposing one or more panels so as to make a desired design; and
installing the panels individually in a top and a bottom rail of the staircase, balcony or fence.

2. The method of claim 1 including the step of attaching stanchions to the panels such that the ends of the stanchions are installable in the top and bottom rail.

3. The method of claim 1 including the step of cutting the sheet of material so as to create attachment elements, the attachment elements being installable in the top and bottom rail.

4. The method of claim 1 including the step of installing the panels in a staircase having an open stringer so that no opening greater in size than a 4 inch diameter object can pass, is created.

5. The method of claim 1, including the step of providing a series of panels at a retail outlet such that the panels can be purchased and installed by an individual.

6. The method of claim 1 including the step of bending the panels after cutting to create the curve of a staircase.

7. The method of claim 1 including the step of creating attachment elements such that the panel can be installed on an inclined surface with the design unaffected by the angle of inclination.

8. The method of claim 1 including the step of attaching alternating panels in a bottom-up configuration so as to vary the design of the ornamental portion.

9. A method of making the ornamental portion of a staircase, balcony or fence from a series of easily installable panels comprising the steps of:
creating a singular panel element from a single sheet of material by cutting away elements of the sheet to make a desired design, including cutting the sheet so as to create attachment elements at the top and bottom of the panel;
surface treating the singular panel at the time of manufacturing so as to provide a protective coating;
juxtaposing one or more panels so as to make a desired design;
installing the panels in a staircase having an open stringer so that no opening greater in size than a 4 inch diameter object can pass, is created.

10. The method of claim 9 including the steps of:
providing holders having a receptor for holding the attachment means; and
installing the panels individually by placing holders at desired locations and inserting the attachment elements within the receptors of the holders.

11. The method of claim 9 including the step of bending the panels after cutting to create the curve of a staircase.

12. The method of claim 9 including the step of attaching alternating panels in a bottom-up configuration so as to vary the design of the ornamentation.

13. A barrier portion of a stairway, balcony, gate, fence or the like comprising:
one or more panels, each being cut from a sheet of material, each panel having a top and bottom, a front and back and a left side and a right side, each panel having one or more attachment means extending from its top and bottom;
wherein each panel comprising an individual design element;
wherein each panel is coated to a finished appearance upon manufacture; and
wherein the barrier portion is created by the assembly of the one or more panels adjacent one another by attaching each, at its top and bottom, to the support structure of the stairway, balcony, gate, fence or the like.

14. The barrier portion of claim 13, including baluster attached to the top and bottom of the support structure.

15. The barrier portion of claim 13, wherein the panels are cut by a computer controlled cutting machine.

16. The barrier portion of claim 13, wherein the panel is cut by a heat element.

17. The barrier portion of claim 16 wherein the heat element is a laser cutter.

18. The barrier portion of claim 15 wherein the cutting element is a water jet cutter.

19. The barrier portion of claim 13 wherein the panels are made of a material from the group consisting of steel, aluminum, copper, bronze, stainless steel, carbon fiber products, graphite, wood and alloys of metals.

20. The barrier portion of claim 13, wherein assembly of the panels is done by mechanical means including fastening each panel to a top and bottom rail of a staircase, balcony gate, fence or the like.

21. The barrier portion of claim 20, wherein the panels are attached to the top and bottom support structure by placing the attachment means of the panel into holes cut into the top and bottom support structure.

22. The barrier portion of claim 13, wherein holders, having attachment means receptors, are attached to the support structure and the panels are attached therein.

23. The barrier portion of claim 15, wherein a desired design is entered into the computer and the cutting element cuts the entered design into the material.

24. The design element of claim 13, wherein the coatings applied to the cut panel are from a group consisting of powder coatings, primers, paints, electroplate metals and epoxies.

25. The barrier portion of claim 13 wherein stanchions are attached to the panels such that the ends of the stanchions are installable in the top and bottom rail.

26. The barrier portion of claim 13 wherein including the step of installing the panels in a staircase having an open stringer so that no opening greater in size than a 4 inch diameter object can pass, is created.
